(19) United States
(12) Patent Application Publication
(10) Pub. No.: US 2021/0250319 A1
(43) Pub. Date: Aug. 12, 2021

(54) IN-VEHICLE COMMUNICATION APPARATUS, COMMUNICATION PROGRAM, AND MESSAGE TRANSMISSION METHOD

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Yuki Sano, Yokkaichi-shi, Mie (JP); Katsuya Ikuta, Yokkaichi-shi, Mie (JP); Tsuyoshi Kontani, Yokkaichi-shi, Mie (JP)

(21) Appl. No.: 17/265,067

(22) PCT Filed: Jul. 29, 2019
(86) PCT No.: PCT/JP2019/029585

§ 371 Date: Feb. 1, 2021

(30) Foreign Application Priority Data
Aug. 10, 2018 (JP) 2018-151264

(51) Int. Cl. H04L 12/58

(52) U.S. Cl. CPC H04L 51/26

(57) ABSTRACT

An in-vehicle communication apparatus includes a classification processing unit that classifies messages to be transmitted to another apparatus, into a plurality of groups and a message transmission unit that selects a group in a predetermined order, and transmits a message classified into the selected group, to the other apparatus. A configuration may be adopted in which the in-vehicle communication apparatus is connected to the other apparatus via a plurality of communication lines, and the message transmission unit selects a group in a predetermined order and transmits a message, for each of the communication lines. A configuration may also be adopted wherein the classification processing unit classifies messages to be transmitted to the other apparatus, into a first group and second group, and the message transmission unit alternately transmits a message classified into the first group and a message classified into the second group, to the other apparatus.

### CROSS-REFERENCE TO RELATED APPLICATIONS

This application is the U.S. national stage of PCT/JP2019/029585 filed on Jul. 29, 2019, which claims priority of Japanese Patent Application No. JP 2018-151264 filed on Aug. 10, 2018, the contents of which are incorporated herein.

### TECHNICAL FIELD

This disclosure relates to an in-vehicle communication apparatus that performs communication in a vehicle, a communication program that is executed by this in-vehicle communication apparatus, and a message transmission method that is performed by this in-vehicle communication apparatus.

### BACKGROUND

Recent years has seen a trend of an increase in the number of ECUs (Electronic Control Units) mounted in a vehicle. Each ECU communicates with another ECU to transmit/receive information to/from the other ECU, and performs various types of processing. Therefore, as the number of ECUs in a vehicle increases, the number of communication lines in the vehicle that are provided for the ECUs to perform communication increases, leading to concerns regarding an increase in the weight of the vehicle, a decrease in the space in the vehicle in which the communication lines are arranged, and the like.

JP 2015-67187A describes a vehicle control system configured such that the inside of a vehicle is divided into a plurality of regions, and, in each of the regions, a plurality of function ECUs are connected to a relay ECU by a first network, and a plurality of relay ECUs are connected by a second network.

However, in the vehicle control system described in JP 2015-67187A, when the communication amount between a plurality of function ECUs provided in different regions increases, there is a risk that the communication band between the relay ECUs that relay the communication between the function ECUs becomes congested, and a communication delay occurs.

The present disclosure has been made in view of such circumstances, and aims to provide an in-vehicle communication apparatus, a communication program, and a message transmission method that can effectively use a communication band, or reduce a communication delay, for example.

### SUMMARY

An in-vehicle communication apparatus according to one aspect of the present disclosure includes: a classification processing unit that performs processing for classifying messages that are to be transmitted to another apparatus, into a plurality of groups, and a message transmission unit that selects a group in a predetermined order, and transmits a message classified into the selected group, to the other apparatus.

A communication program according to another aspect of the present disclosure causes an in-vehicle communication apparatus to perform processing for classifying messages that are to be transmitted to another apparatus, into a plurality of groups, and selecting a group in a predetermined order and transmitting a message classified into the selected group to the other apparatus.

A message transmission method according to another aspect of the present disclosure includes classifying messages that are to be transmitted to an apparatus, into a plurality of groups, and selecting a group in a predetermined order and transmitting a message classified into the selected group, to the apparatus.

Note that the present application can be realized not only as an in-vehicle communication apparatus that includes the above-described characteristic processing units, but also as a message transmitting method that includes the above-described characteristic processing as steps, or a communication program for causing a computer to execute the steps. In addition, the present application can be realized as a semiconductor integrated circuit that realizes a portion or the entirety of the in-vehicle communication apparatus, or another apparatus or system that includes the in-vehicle communication apparatus.

### Advantageous Effects of Disclosure

According to the above aspects, it is possible to effectively use a communication band, or reduce a communication delay, for example.

### BRIEF DESCRIPTION OF DRAWINGS

FIG. 1 is a block diagram showing a configuration of an in-vehicle communication system according to an embodiment of the present disclosure.

FIG. 2 is a block diagram showing a configuration of a GW according to an embodiment of the present disclosure.

FIG. 3 is a schematic diagram showing a configuration example of a load table.

FIG. 4 is a schematic diagram for illustrating an example of criteria for determining a communication load of a message.

FIG. 5 is a schematic diagram for illustrating processing that is performed by a GW according to an embodiment of the present disclosure, the processing being for transmitting messages to another GW.

FIG. 6 is a flowchart showing the procedure of message classification processing that is performed by a GW according to an embodiment of the present disclosure.

FIG. 7 is a flowchart showing the procedure of message transmission processing that is performed by a GW according to an embodiment of the present disclosure.

FIG. 8 is a flowchart showing the procedure of processing for updating a load table that is performed by a GW according to Modified Example 1.

FIG. 9 is a schematic diagram for illustrating processing that is performed by a GW according to Modified Example 2, the processing being for transmitting messages to another GW.

FIG. 10 is a flowchart showing the procedure of message classification processing that is performed by a GW according to Modified Example 2.

FIG. 11 is a flowchart showing the procedure of message transmission processing that is performed by the GW according to Modified Example 2.

### DETAILED DESCRIPTION OF PREFERRED EMBODIMENTS

First, embodiments of the present disclosure will be listed and described. At least some of the embodiments to be described below may be suitably combined.

An in-vehicle communication apparatus according to one aspect of the present disclosure includes: a classification processing unit that performs processing for classifying messages that are to be transmitted to another apparatus, into a plurality of groups, and a message transmission unit that selects a group in a predetermined order, and transmits a message classified into the selected group, to the other apparatus.

In this aspect, the in-vehicle communication apparatus classifies messages that are to be transmitted to the other apparatus, into a plurality of groups. The in-vehicle communication apparatus selects one group from the plurality of groups in a predetermined order, and transmits a message classified into the selected group, to the other apparatus. As a result of appropriately classifying messages into a plurality of groups, it is possible to effectively use a communication band, or reduce a communication delay, for example.

It is preferred that the in-vehicle communication apparatus is connected to the other apparatus via a plurality of communication lines, and the message transmission unit selects a group in a predetermined order and transmits a message, for each of the communication lines.

In this aspect, the in-vehicle communication apparatus and one other apparatus are connected via a plurality of communication lines. Accordingly, it is possible to widen the communication band between the in-vehicle communication apparatus and the other apparatus. In addition, regarding messages classified into a plurality of groups, a group is selected and a message is transmitted for each of the communication lines. Accordingly, the widened communication band can be effectively used.

It is preferred that the classification processing unit classifies messages that are to be transmitted to the other apparatus, into a first group and a second group, and the message transmission unit alternately transmits, to the other apparatus, a message classified into the first group and a message classified into the second group.

In this aspect, messages are classified into two groups, namely the first and second groups. The in-vehicle communication apparatus alternately transmits a message classified into the first group and a message classified into the second group. As a result of classifying messages into two groups, namely the first and second groups, classification can be simplified.

The classification processing unit preferably classifies a message in accordance with whether a communication load of the message is large or small.

In this aspect, a message that is to be transmitted to the other apparatus is classified in accordance with whether the communication load of the message is large or small. A determination can be made as to whether a communication load of a message is large or small, for example, based on the data length, transmission cycle, and the like of the message. Accordingly, the in-vehicle communication apparatus can effectively use the communication band by transmitting messages classified in accordance with the communication load, in a predetermined order.

It is preferred that the message includes identification information, the classification processing unit classifies the message based on information regarding a correspondence between the identification information and communication load of the message, and an update unit that updates the correspondence information based on a history of message transmission to the other apparatus is provided.

In this aspect, a message that is transmitted/received by the in-vehicle communication apparatus includes identification information indicating the type of information included in the message, the source of the message, and the like. The in-vehicle communication apparatus stores information regarding a correspondence between identification information and a communication load of a message, and classifies messages that are to be transmitted, into a plurality of groups, based on this correspondence information. In addition, the in-vehicle communication apparatus updates this correspondence information based on a history of message transmission. Accordingly, the in-vehicle communication apparatus can perform classification in correspondence with a change in the communication state and the like.

It is preferred that the message includes priority information, and the message transmission unit preferentially transmits a message with a predetermined priority, regardless of classification into one of the plurality of groups.

In this aspect, a message that is transmitted/received by the in-vehicle communication apparatus includes priority information indicating the priority of the message. Note that the priority information may be information that is also used as the above-described identification information. The in-vehicle communication apparatus preferentially transmits a message with a predetermined priority, regardless of classification into one of the plurality of groups. Accordingly, it is possible to prevent a delay of a message that is to be preferentially transmitted.

A communication program according to another aspect causes an in-vehicle communication apparatus to perform processing for classifying messages that are to be transmitted to another apparatus, into a plurality of groups, and selecting a group in a predetermined order and transmitting a message classified into the selected group, to the other apparatus.

In this aspect, similarly to the first aspect, it is possible to effectively use a communication band, or reduce a communication delay, for example.

A message transmission method according to another aspect includes: classifying messages that are to be transmitted to an apparatus, into a plurality of groups, and selecting a group in a predetermined order and transmitting a message classified into the selected group, to the apparatus.

In this aspect, similarly to the first aspect, it is possible to effectively use a communication band, or reduce a communication delay, for example.

Specific examples of an in-vehicle communication apparatus according to embodiments of the present disclosure will be described below with reference to the drawings. Note that the present disclosure is not limited to illustrations of these, but is indicated by the claims, and all changes that come within the meaning and range of equivalency of the claims are intended to be embraced therein.

### System Configuration

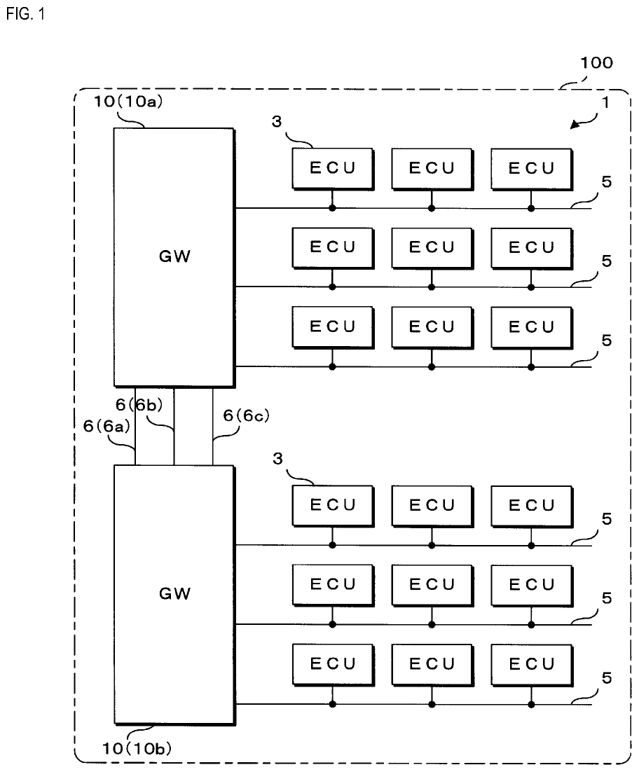

FIG. 1 is a block diagram showing a configuration of an in-vehicle communication system according to an embodiment. An in-vehicle communication system 1 according to a first embodiment is a system that includes, in a vehicle 100, a plurality of ECUs 3 and a plurality of GWs (Gate Ways) 10, and in which the plurality of ECUs 3 and GWs 10 transmit/receive messages via communication lines 5 and 6. As an example, FIG. 1 shows the configuration of the in-vehicle communication system 1 in which two GWs 10 are mounted in the vehicle 100, and the two GWs 10 are connected via three communication lines 6, three communication lines 5 are connected to each of the GWs 10, and three ECUs 3 are connected to each of the communication lines 5. In the following description, when the two GWs 10 need to be distinguished from each other, different reference numerals are used, for example, one is defined as a GW 10a, and the other is defined as a GW 10b, as shown in FIG. 1. Similarly, as necessary, the three communication lines 6 are distinguished from each other as communication lines 6a, 6b and 6c. Note that the number of ECUs 3, the number of GWs 10, the number of communication lines 5, and the number of communication lines 6 that are included in the in-vehicle communication system 1, the connection modes of the apparatuses, the network configuration, and the like are not limited to those illustrated.

The ECUs 3 mounted in the vehicle 100 may include various ECUs such as an ECU for controlling the operation of the engine of the vehicle 100, an ECU for controlling the locking/unlocking of the doors, an ECU for controlling on/off of lights, an ECU for controlling the operation of the air bags, and an ECU for controlling the operation of the ABS (Antilock Brake System). Each ECU 3 is connected to one of the communication lines 5 arranged in the vehicle 100, and can transmit/receive messages to/from other ECUs 3 via the communication lines 5 and the GWs 10.

Each of the GWs 10 is connected to a plurality of communication lines 5, and can transmit/receive messages to/from a plurality of ECUs 3 via the communication lines 5. A GW 10 that has received a message transmitted by an ECU 3 determines whether or not the received message needs to be relayed, based on the ID assigned to the message, and transmits the message, if it needs to be relayed, using a communication line 5 different from the communication line 5 from which the message was received. Therefore, the GW 10 has a destination map that stores a correspondence relation between an ID assigned to a message and a communication line 5 through which this message is to be transmitted.

In the in-vehicle communication system 1, a message can be transmitted from an ECU 3 connected to one GW, namely the GW 10a to an ECU 3 connected to the other GW, namely the GW 10b. In this case, the GW 10a that has received a message from the ECU 3 determines that the message is to be transmitted to the other GW, namely the GW 10b, based on the ID assigned to this message, and outputs this message from a communication line 6, so as to transmit it to the GW 10b. The GW 10b that has received the message from the GW 10a via the communication line 6 determines which communication line 5 the message is to be relayed to, based on the ID assigned to the received message, and transmits this message from the communication line 5 to which the message is to be relayed. The same applies when a message is transmitted from the GW 10b to the GW 10a.

In addition, in the in-vehicle communication system 1 according to the first embodiment, the two GWs 10 are connected via the three communication lines 6. The three communication lines 6 comply with the same communication standard, and the communication standard of the CAN (Controller Area Network), Ethernet (registered trademark), FlexRay, or the like may be adopted. In addition, in this embodiment, the communication speed is the same regardless of which communication line 6 is used for the GW 10 to perform communication.

When one of the GWs 10 transmits a message to the other GW 10, one of the three communication lines 6 is selected, and this message is transmitted from the selected communication line 6. Each of the GWs 10 according to this embodiment classifies a message that is to be transmitted to the other GW 10, into a first group of messages for which the communication load is large or a second group of messages for which the communication load is small, in accordance with the communication load of the message. The GW 10 alternately transmits a message for which the communication load is large and a message for which the communication load is small, for each communication line 6.

### Apparatus Configuration

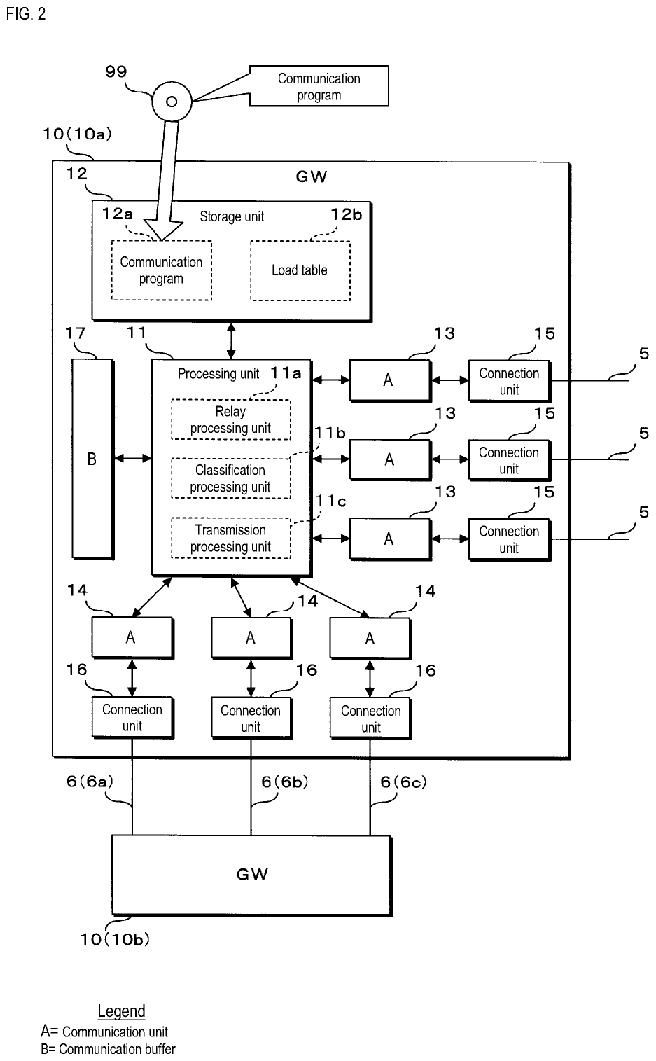

FIG. 2 is a block diagram showing a configuration of a GW 10 according to this embodiment. Note that the two GWs 10 of the in-vehicle communication system 1 according to this embodiment have substantially the same configuration, and thus FIG. 2 illustrates a detailed configuration of only one GW, namely the GW 10a, and thus a description of a detailed configuration of the other GW, namely the GW 10b is omitted. Each of the GWs 10 according to this embodiment is configured to include a processing unit (processor) 11, a storage unit (storage) 12, communication units (transceivers) 13 and 14, connection units (connectors) 15 and 16, a communication buffer 17, and the like.

The processing unit 11 is constituted by a computation processing apparatus such as a CPU (Central Processing Unit) or MPU (Micro-Processing Unit). The processing unit 11 can perform various types of processing by reading out and executing a program stored in the storage unit 12. In this embodiment, the processing unit 11 performs processing for relaying a message between communication lines 5, processing for classifying a message that is to be transmitted to the other GW 10, processing for transmitting a classified message to the other GW 10, and the like, by reading out and executing a communication program 12a stored in the storage unit 12.

The storage unit 12 is constituted by a non-volatile memory element such as a flash memory or EEPROM (Electrically Erasable Programmable Read Only Memory). The storage unit 12 stores various programs that are executed by the processing unit 11, and various types of data required for processing that is performed by the processing unit 11. In this embodiment, the storage unit 12 stores the communication program 12a that is executed by the processing unit 11, and a load table 12b that is used when the processing unit 11 classifies a message that is to be transmitted to the other GW 10. Note that the communication program 12a may also be written in the storage unit 12 in a manufacturing stage of the GW 10, for example, or may also be distributed by a remote server apparatus or the like and obtained by the GW 10 through communication, for example, or the program recorded in a recording medium 99 such as a memory card or an optical disk may also be read out by the GW 10 and stored in the storage unit 12, for example, or the program recorded in the recording medium 99 may also be read out by a writing apparatus and written in the storage unit 12 of the GW 10 by the writing apparatus, for example. The communication program 12a may also be provided in a mode of being distributed via a network, or may also be provided in a mode of being recorded in the recording medium 99.

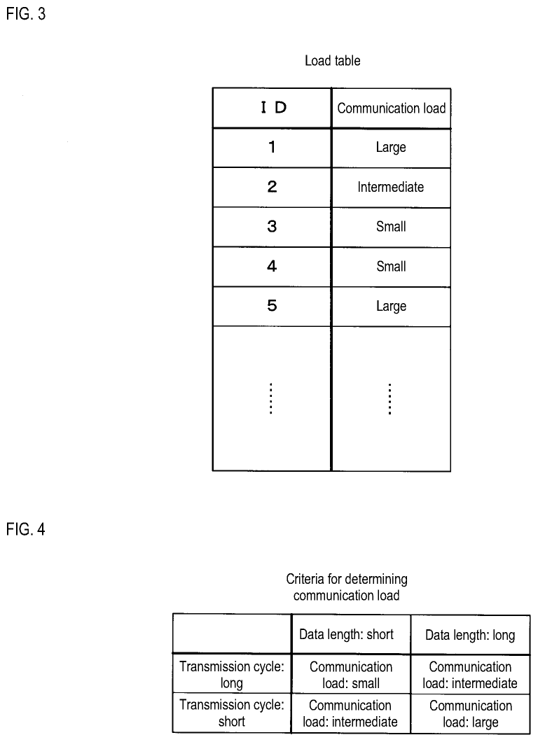

FIG. 3 is a schematic diagram showing a configuration example of the load table 12b. The load table 12b that is stored in the storage unit 12 of a GW 10 according to this embodiment is a table in which an ID assigned to a message that may be transmitted/received by the GW 10 and the communication load of this message are associated with each other. In this embodiment, the communication load of a message is indicated by one of three levels, namely “large”, “intermediate”, and “small”, but there is no limitation thereto, and, for example, there may be two levels, namely “large” and “small”, or four levels or more. In addition, the load table 12b is used in message classification processing to be described later, and, in this classification processing, messages are classified into two groups, namely a first group and a second group in accordance with communication loads. Therefore, the load table 12b may store classification groups for IDs of messages (in other words, the first group or second group) instead of communication loads for IDs of messages. The load table 12b is created in advance, for example, at the stage of designing the GW 10, the in-vehicle communication system 1, the vehicle 100, or the like, and is written in the storage unit 12 during the manufacturing process of the GW 10.

FIG. 4 is a schematic diagram for illustrating an example of criteria for determining a communication load of a message. The load table 12b is created by the designer or the like of the GW 10 or the in-vehicle communication system 1 in advance based on the determination criteria shown in FIG. 4. In this embodiment, the communication load of a message is determined as being one of three levels based on the data length and the transmission cycle of the message. The data length of a message is determined as being “long” or “short” by comparing it with a predetermined threshold value such as X bytes. The transmission cycle of a message is determined as being “long” or “short” by comparing it with a predetermined threshold value such as Y milliseconds. In this embodiment, the communication load of a message whose data length is short and whose transmission cycle is long is determined as being small, and the communication load of a message whose data length is long and whose transmission cycle is short is determined as being large. The communication loads for messages other than those above, in other words a message whose data length is short and transmission cycle is short and a message whose data length is long and transmission cycle is long are determined as being intermediate.

The connection units 15 and 16 are connection units for detachably connecting the communication lines 5 and 6 to the GW 10, and are so-called connectors. The connection units 15 and 16 are configured to be appropriate for the shapes, communication standards, and the like of the communication lines 5 and 6 connected thereto. Note that FIG. 2 illustrates three connection units 15 for connecting, to the GW 10, the communication lines 5 for communicating with the ECUs 3 and three connection units 16 for connecting, to the GW 10, the communication lines 6 for communicating with the other GW 10, using different reference numerals. However, when communication between the GW 10 and each ECU 3 and communication between the two GWs 10 are performed in compliance with the same communication standard, and the communication lines 5 and 6 comply with the same standard, the connection units 15 and 16 may substantially be the same.

The communication units 13 and 14 perform processing related to transmission/receiving of a message via the communication lines 5 and 6 connected to the connection units 15 and 16, respectively. The communication units 13 and 14 may be constituted by communication ICs. The communication units 13 and 14 convert an electrical signal on the communication lines 5 and 6 into digital data by periodically sampling and obtaining the potentials of the communication lines 5 and 6 connected to the connection units 15 and 16, respectively, and supply this digital data as a received message to the processing unit 11. In addition, the communication units 13 and 14 convert a message supplied as digital data from the processing unit 11, into an electrical signal, and output the converted electrical signal to the communication lines 5 and 6 connected to the connection units 15 and 16, respectively, thereby transmitting the message. Note that FIG. 2 illustrates three communication units 13 that communicate with the ECUs 3 and three communication units 14 that communicate with the other GW 10, using different reference numerals. However, when communication between the GW 10 and each ECU 3 and communication between the two GWs 10 are performed in compliance with the same communication standard, the communication units 13 and 14 may substantially be the same.

The communication buffer 17 is constituted by a data-rewritable memory element such as an SRAM (Static Random Access Memory) or DRAM (Dynamic Random Access Memory). The communication buffer 17 temporarily stores a message received from an ECU 3 or the other GW 10. In the GW 10 according to this embodiment, two buffers, namely a first buffer and a second buffer are provided in the communication buffer 17, and a message to be transmitted to the other GW 10 is stored in one of the buffers in accordance with a classification result.

In addition, in the GW 10 according to this embodiment, a relay processing unit 11a, a classification processing unit lib, a transmission processing unit 11c, and the like are realized as software-like functional blocks in the processing unit 11, as a result of the processing unit 11 reading out and executing the communication program 12a stored in the storage unit 12. The relay processing unit 11a performs processing for relaying a message received from an ECU 3 by a communication unit 13, to another ECU 3. The relay processing unit 11a obtains the ID assigned to the message received by the communication unit 13, refers to the destination map, and confirms the destination associated with the ID using the destination map. The relay processing unit 11a supplies the message to a communication unit 13 that is a destination designated in the destination map, and makes the communication unit 13 transmit the message to the communication lines 5. In addition, when the destination designated in the destination map is the other GW 10, the relay processing unit 11a supplies the message to be transmitted to the other GW 10, to the classification processing unit lib.

When the message to be transmitted to the other GW 10 is supplied from the relay processing unit 11a, the classification processing unit lib performs processing for classifying this message into the first group of messages for which communication loads are large or the second group of messages for which communication loads are small, based on the ID assigned to the message and the load table 12b stored in the storage unit 12. The classification processing unit lib classifies a message for which the communication load is large, into the first group, and classifies a message for which the communication load is small, into the second group. In addition, it suffices for the classification processing unit lib to classify a message for which the communication load is intermediate, into the first group or the second group as appropriate. The classification processing unit lib may alternately classify a message for which the communication load is intermediate into the first group or second group, for example, or may also randomly classify a message for which the communication load is intermediate, into the first group or second group, for example, and classification may also be performed using a method different from those described above. The classification processing unit lib stores messages classified into the first group, in the first buffer of the communication buffer 17, and stores messages classified into the second group, in the second buffer of the communication buffer 17. Note that the first buffer and the second buffer are FIFO (First In First Out) buffers.

The transmission processing unit 11c obtains, from the first buffer and the second buffer of the communication buffer 17, messages that are to be transmitted to the other GW 10 and have been classified by the classification processing unit 11b, and supplies the message to a communication unit 14, thereby performing message transmission processing. In this embodiment, the transmission processing unit 11c alternately obtains messages from the first buffer and the second buffer, and supplies the obtained messages to a communication unit 14. The communication unit 14 outputs the messages supplied from the processing unit 11, to the communication line 6 connected to the connection unit 16 corresponding to this communication unit 14, and thereby transmits the message the other GW 10.

Note that FIG. 2 illustrates one transmission processing unit 11c, but the same number of transmission processing units 11c as the number of communication units 14 that communicate with the other GW 10 are provided in the processing unit 11 of the GW 10. Specifically, in this embodiment, three transmission processing units 11c are provided in the processing unit 11. The three transmission processing units 11c independently perform the above-described processing in parallel. Each of the transmission processing units 11c obtains messages from the first buffer and the second buffer, and supplies the obtained messages to the communication unit 14 associated with the transmission processing unit 11c, thereby transmitting the messages.

### Message Transmission Processing

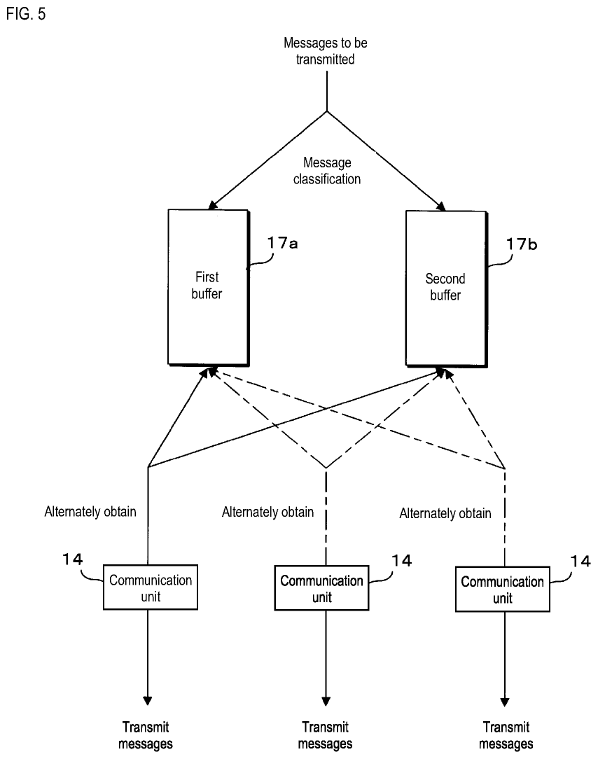

FIG. 5 is a schematic diagram for illustrating processing that is performed by one GW 10 according to this embodiment, the processing being for transmitting a message to the other GW 10. The GW 10 according to this embodiment receives a message from an ECU 3 connected thereto via a communication line 5, and relays this message to another ECU 3. At this time, when the ECU 3 to which the message is to be relayed is connected to the other GW 10, the GW 10 transmits this message to the other GW 10. The classification processing unit lib of the GW 10 classifies this message to be transmitted to the other GW 10, into the first group of messages for which the communication loads are large or the second group of messages for which the communication loads are small, based on the ID assigned to the message and the load table 12b stored in the storage unit 12. The classification processing unit lib stores a message classified into the first group, in a first buffer 17a of the communication buffer 17, and a message classified into the second group, in a second buffer 17b.

The three transmission processing units 11c provided in association with the three communication units 14 of the GW 10 obtain messages stored in the first buffer 17a and the second buffer 17b, and supply the messages respectively to the corresponding communication units 14, thereby transmitting the messages to the other GW 10. At this time, each of the transmission processing units 11c alternately obtains messages from the first buffer 17a and the second buffer 17b. Messages are obtained from the first buffer 17a and the second buffer 17b by the three transmission processing units 11c asynchronously, in parallel, and exclusively. Note that, when no message is stored in one of the first buffer 17a and the second buffer 17b, each transmission processing unit 11c may continuously obtain messages from the buffer in which messages are stored.

Accordingly, each communication unit 14 alternately transmits, to the other GW 10, a message that is stored in the first buffer 17a and belongs to the first group of messages for which the communication load is large and a message that is stored in the second buffer 17b and belongs to the second group of messages for which the communication load is small.

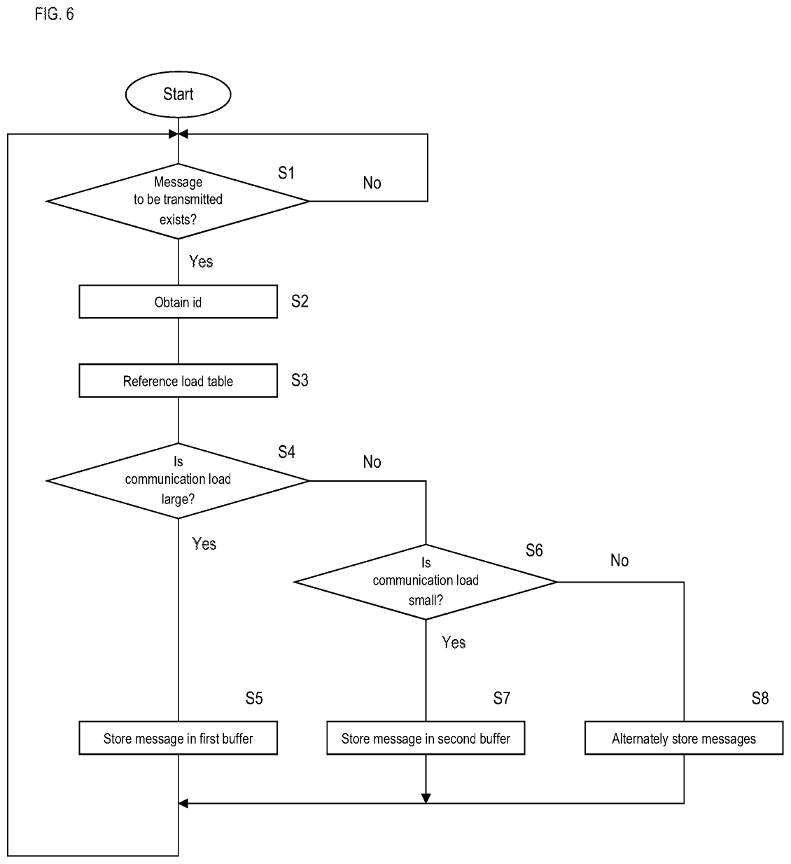

FIG. 6 is a flowchart showing the procedure of message classification processing that is performed by a GW 10 according to this embodiment. The classification processing unit lib of the processing unit 11 of the GW 10 according to this embodiment determines the presence or absence of any message that is to be transmitted to the other GW 10 (step S1). If there is no message to be transmitted to the other GW 10 (step S1: NO), the classification processing unit 11b waits until a message to be transmitted to the other GW 10 is supplied. When there is a message to be transmitted to the other GW 10 (step S1: YES), the classification processing unit lib obtains the ID included in this message (step S2). The classification processing unit 11b references the load table 12b stored in the storage unit 12 based on the obtained ID (step S3).

The classification processing unit lib determines whether or not the communication load of this message is large, based on the result of referencing the load table 12b (step S4). If the communication load is large (step S4: YES), the classification processing unit lib classifies this message into the first group, stores the message in the first buffer 17a corresponding to the first group (step S5), and returns the procedure to step S1. If the communication load is not large (step S4: NO), the classification processing unit lib determines whether or not the communication load of this message is small (step S6). If the communication load is small (step S6: YES), the classification processing unit lib classifies this message into the second group, stores the message in the second buffer 17b corresponding to the second group (step S7), and returns the procedure to step S1.

If the communication load of this message is not small (step S6: NO), in other words if the communication load is intermediate, the classification processing unit lib alternately stores this message in the first buffer 17a or the second buffer 17b (step S8), and returns the procedure to step S1. In step S8, if the lastly handled message was stored in the first buffer 17a, the classification processing unit lib stores the current message in the second buffer 17b, and, if the lastly handled message was stored the second buffer 17b, the classification processing unit lib stores the current message in the first buffer 17a. Here, “the lastly handled message” may be not only a message for which the communication load is intermediate, but also a message for which the communication load is large or a message for which the communication load is small. Note that “the lastly handled message” may also only be a message for which the communication load is intermediate.

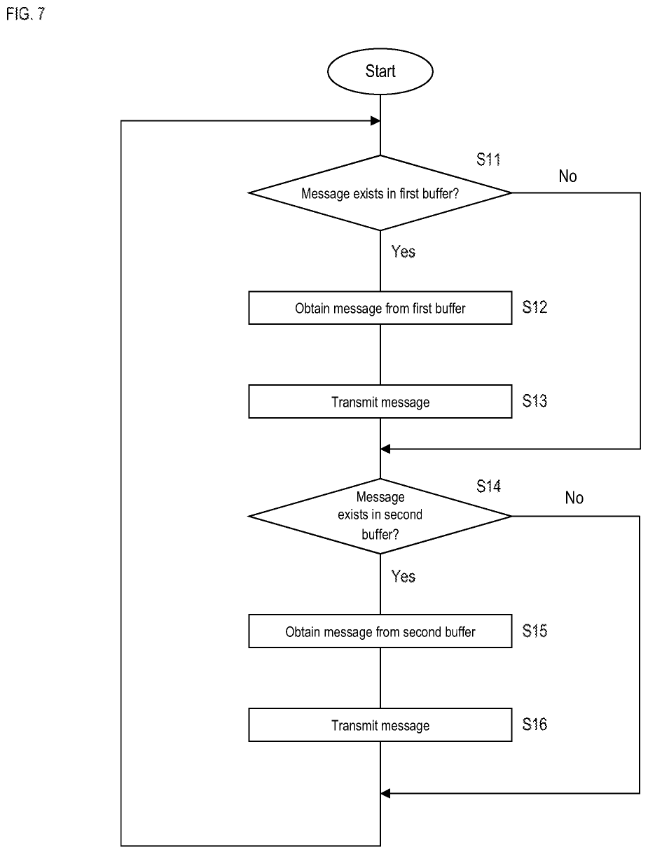

FIG. 7 is a flowchart showing the procedure of message transmission processing that is performed by a GW 10 according to this embodiment. Note that this flowchart illustrates processing that is individually performed by the three transmission processing units 11c provided in correspondence with the three communication units 14 of the GW 10. The three transmission processing units 11c execute this processing in parallel. Each transmission processing unit 11c of the GW 10 according to this embodiment determines whether or not a message is stored in the first buffer 17a (step S11). If a message is stored in the first buffer 17a (step S11: YES), the transmission processing unit 11c obtains the message from the first buffer 17a (step S12). The transmission processing unit 11c supplies the obtained message to the communication unit 14, thereby transmits this message to the other GW 10 (step S13), and advances the procedure to step S14. In addition, if no message is stored in the first buffer 17a (step S11: NO), the transmission processing unit 11c advances the procedure step S14.

Next, the transmission processing unit 11c determines whether or not a message is stored in the second buffer 17b (step S14). If a message is stored in the second buffer 17b (step S14: YES), the transmission processing unit 11c obtains this message from the second buffer 17b (step S15). The transmission processing unit 11c supplies the obtained message to the communication unit 14, thereby transmits this message to the other GW 10 (step S16), and returns the procedure to step S11. In addition, if no message is stored in the second buffer 17b (step S14: NO), the transmission processing unit 11c returns the procedure to step S11.

### Overview

Each GW 10 according to this embodiment that has the above-described configuration classifies messages that are to be transmitted to the other GW 10, into two groups, namely the first and second groups. The GW 10 alternately transmits, to the other GW 10, a message classified into the first group and a message classified into the second group. It is possible to effectively use a communication band between the two GWs 10, or reduce a communication delay, for example, by appropriately classifying messages into the first group and second group.

In addition, in the in-vehicle communication system 1 according to this embodiment, the two GWs 10 are connected via the three communication lines 6. Accordingly, it is possible to widen the communication band between the two GWs 10. In addition, alternate transmission of a message classified into the first group and a message classified into the second group is performed for each communication line. Accordingly, the communication load can be distributed, and the communication band can be effectively used.

In addition, each message that is transmitted/received in the in-vehicle communication system 1 according to this embodiment includes identification information indicating the type of information included in the message, the source of the message, or the like. The storage unit 12 of the GW 10 according to this embodiment stores, as the load table 12b, information regarding a correspondence between the ID and the communication load of a message. The GW 10 classifies a message that is to be transmitted to the other GW 10, into the first group or second group, based on the ID of the message and the load table 12b of the storage unit 12. Accordingly, classification of a message performed by the GW 10 can be easily set using the load table 12b.

Note that, in this embodiment, the GWs 10 each mounted as an in-vehicle communication apparatus in the vehicle 100 have been described as an example, but the in-vehicle communication apparatus is not limited to a GW 10. For example, the ECUs 3 may have similar message classification and transmission functions. The in-vehicle communication apparatus may be an apparatus different from a GW 10 and an ECU 3. In addition, a configuration is adopted in which the two GWs 10 are connected via the three communication lines 6, but there is no limitation thereto, and the two GWs 10 may be connected via one, two, or four more communication lines 6. In addition, a configuration is adopted in which the two GWs 10 are mounted in the vehicle 100, but there is no limitation thereto, and one or three or more GWs 10 may also be mounted in the vehicle 100.

In addition, a configuration is adopted in which, in the load table 12b, a communication load of a message is set at one out of three levels, namely “large”, “intermediate”, or “small”, but there is no limitation thereto. In the load table 12b, a communication load of a message may also be set at one out of two levels, namely large or small, or one out of four levels or more. In addition, a configuration is adopted in which each GW 10 classifies messages into two groups, namely the first and second groups, but a configuration may also be adopted in which messages are classified into three or more groups. For example, a configuration can be adopted in which the GW 10 classifies messages into first to third groups in accordance with whether the communication loads of the messages are “large”, “intermediate”, or “small”, stores the messages in the first to third buffers, and obtains and transmits messages in a predetermined order, for example, in the order of the first buffer, the second buffer, the third buffer, the first buffer . . . . Furthermore, the GW 10 may also classify messages into n groups, namely first to nth groups, and store the messages in first to nth buffers. A configuration can be adopted in which the GW 10 selects one group from the n groups in a predetermined order, for example, in the order of the first buffer, the second buffer, . . . , the nth buffer, the first buffer, . . . , and obtains messages classified into the selected group, from the corresponding buffer, and transmits the messages.

### Modified Example 1

A GW 10 according to Modified Example 1 performs processing for periodically updating the load table 12b stored in the storage unit 12. Every time a message is transmitted, the GW 10 according to Modified Example 1 stores the ID, message length, and transmission cycle of the message in association with each other, as history information in the storage unit 12, and accumulates such information. Note that a transmission cycle of a (current) message can be obtained by measuring the length of time from when a message having the same ID was previously transmitted to when this current message is transmitted, using a clocking function of the processing unit 11, for example. The message length of a message is stored as a number of bytes, a number of bits, or the like.

At a predetermined update timing, the GW 10 according to Modified Example 1 performs processing for updating the load table 12b based on the history information accumulated in the storage unit 12. The GW 10 may perform update processing in every predetermined period such as every day or every month, or the GW 10 may perform update processing, for example, when an ignition switch of the vehicle 100 is switched to an on-state, or, for example, when the accumulated amount of history information exceeds a threshold value, or the GW 10 may perform update processing at a timing other than those described above. The GW 10 calculates a message length and transmission cycle for each ID of messages based on the accumulated history information, and determines a communication load of a message in accordance with the determination criteria shown in FIG. 4. The GW 10 updates settings of a communication load for each ID in the load table 12b according to this determination result. Therefore, the storage unit 12 of the GW 10 according to Modified Example 1 stores the determination criteria in FIG. 4.

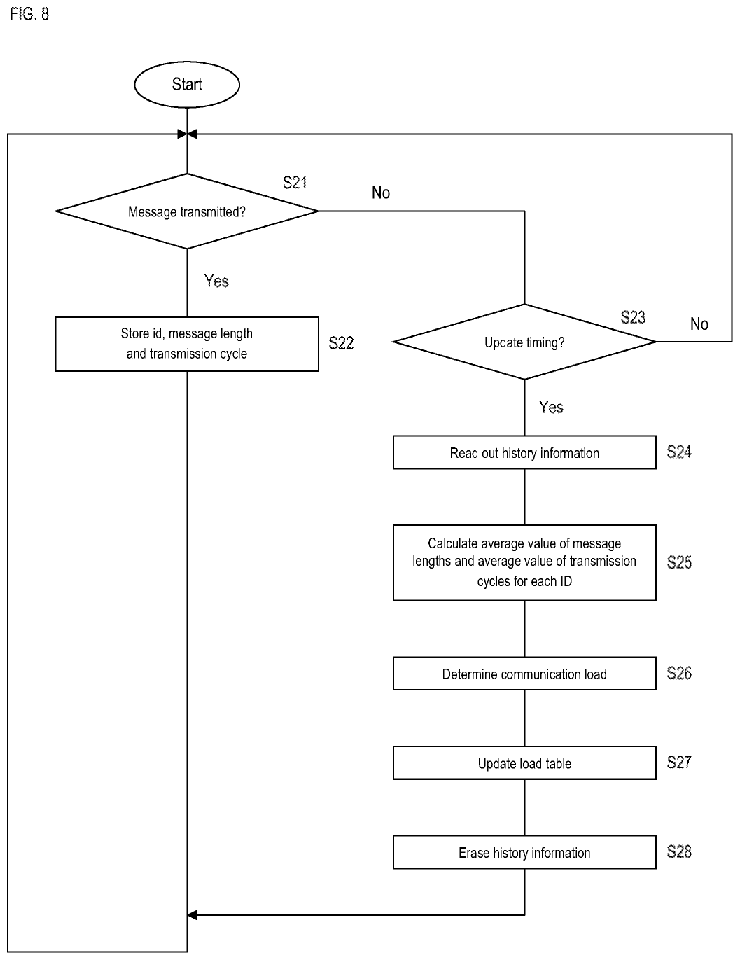

FIG. 8 is a flowchart showing the procedure of processing for updating the load table that is performed by the GW 10 according to Modified Example 1. The processing unit 11 of the GW 10 according to Modified Example 1 determines whether or not one of the communication units 14 has transmitted a message (step S21). If one communication unit 14 has transmitted a message (step S21: YES), the processing unit 11 stores the ID, message length, and transmission cycle of the transmitted message as history information in the storage unit 12 (step S22), and returns the procedure to step S21.

If none of the communication units 14 has transmitted a message (step S21: NO), the processing unit 11 determines whether or not it is the timing for updating the load table 12b (step S23). If it is not yet the update timing (step S23: NO), the processing unit 11 returns the procedure to step S21. If it is the update timing (step S23: YES), the processing unit 11 reads out the history information stored in the storage unit 12 (step S24). The processing unit 11 calculates the average value of message lengths and the average value of transmission cycles for each of the IDs of messages based on the read history information (step S25). Note that, if a message length is determined as an invariable for each ID, the average value of message lengths does not need to be calculated.

Next, the processing unit 11 determines a communication load for each of the IDs of messages, based on the message length and transmission cycle calculated in step S25 and the determination criteria stored in the storage unit 12 (step S26). The processing unit 11 updates the load table 12b stored in the storage unit 12 according to the communication load determined for each ID (step S27). The processing unit 11 then erases the history information stored in the storage unit 12 (step S28), and returns the procedure to step S21.

The GW 10 according to Modified Example 1 that has the above-described configuration accumulates history information of message transmission, and performs processing for updating the load table 12b based on the history information at the predetermined update timing. Accordingly, when the communication state changes, for example, when a new ECU 3 is added to the in-vehicle communication system 1, the GW 10 can classify messages appropriately for this change.

### Modified Example 2

A GW 10 according to Modified Example 2 transmits messages in consideration of their priorities. For example, the GW 10 according to Modified Example 2 uses the ID assigned to a message as information indicating the priority of the message. A smaller value of an ID assigned to a message according to Modified Example 2 indicates a higher priority, and a larger value indicates a lower priority. The GW 10 according to Modified Example 2 preferentially transmits, to the other GW 10, a message with a higher priority than a predetermined threshold value.

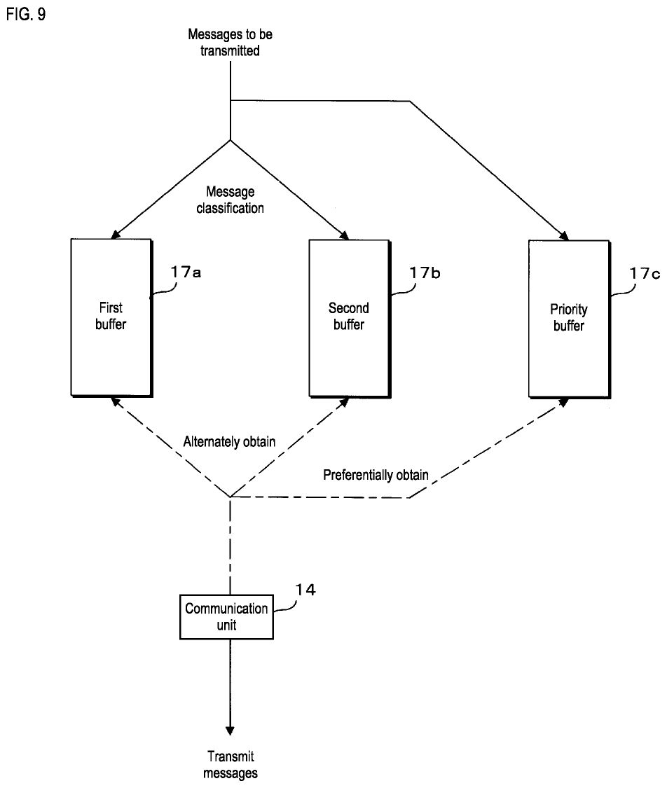

FIG. 9 is a schematic diagram for illustrating processing that is performed by the GW 10 according to Modified Example 2, the processing being for transmitting messages to the other GW 10. Note that, in FIG. 9, only one communication unit 14 is illustrated for simplification, but the GW 10 may include a plurality of communication units 14. The classification processing unit 11b of the GW 10 according to Modified Example 2 classifies, as a priority message, a message with a higher priority than the threshold value from among messages that are to be transmitted to the other GW 10, and classifies messages other than the priority message into the first group and second group in accordance with their communication loads. In addition, the communication buffer 17 of GW 10 according to Modified Example 2 includes a priority buffer 17c for storing the priority message in addition to the first buffer 17a and the second buffer 17b. The classification processing unit lib stores a message classified as a priority message, in the priority buffer 17c. In addition, the classification processing unit lib stores messages other than the priority message in the first buffer 17a or the second buffer 17b based on the classification result.

The transmission processing unit 11c of the GW 10 according to Modified Example 2 first confirms whether or not a message is stored in the priority buffer 17c, and if a message is stored, the transmission processing unit 11c obtains this message, supplies this message to the communication unit 14, and transmits the priority message to the other GW 10. If no message is stored in the priority buffer 17c, the transmission processing unit 11c obtains a message from the first buffer 17a or the second buffer 17b, and supplies the obtained message to the communication unit 14. At this time, the transmission processing unit 11c alternately obtains messages from the first buffer 17a and the second buffer 17b.

Accordingly, the communication unit 14 preferentially transmits a higher-priority message stored in the priority buffer 17c, to the other GW 10. In addition, regarding lower-priority messages, the communication unit 14 alternately transmits, to the other GW 10, a message that is stored in the first buffer 17a and belongs to the first group of messages for which communication loads are large and a message that is stored in the second buffer 17b and belongs to the second group of messages for which communication loads are small.

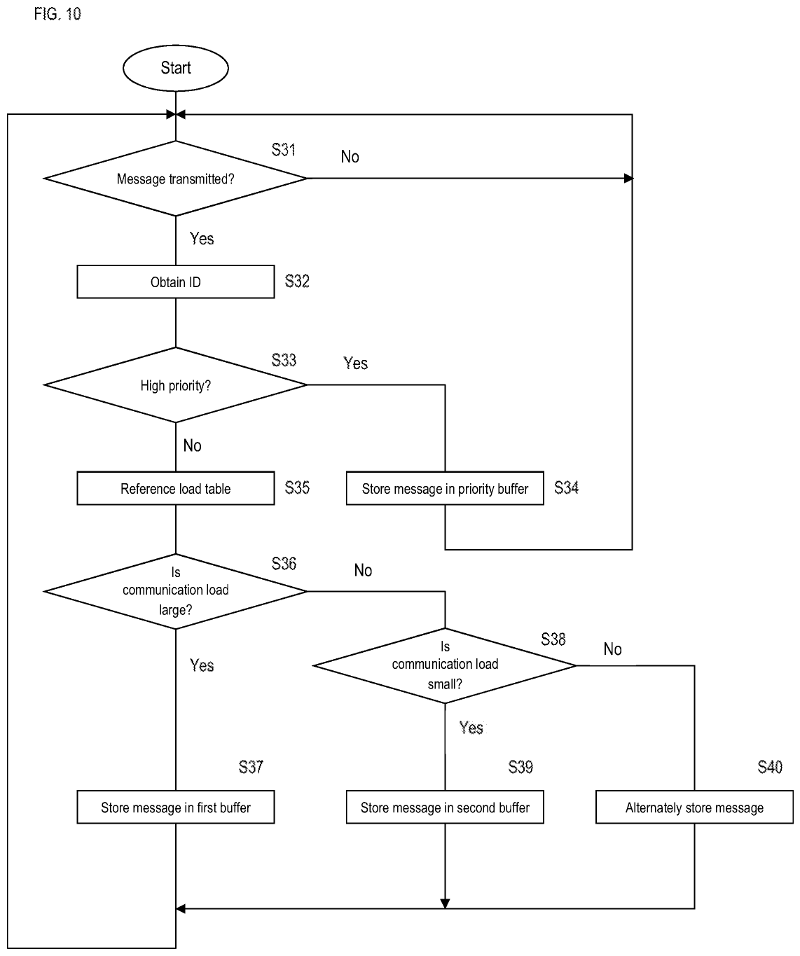

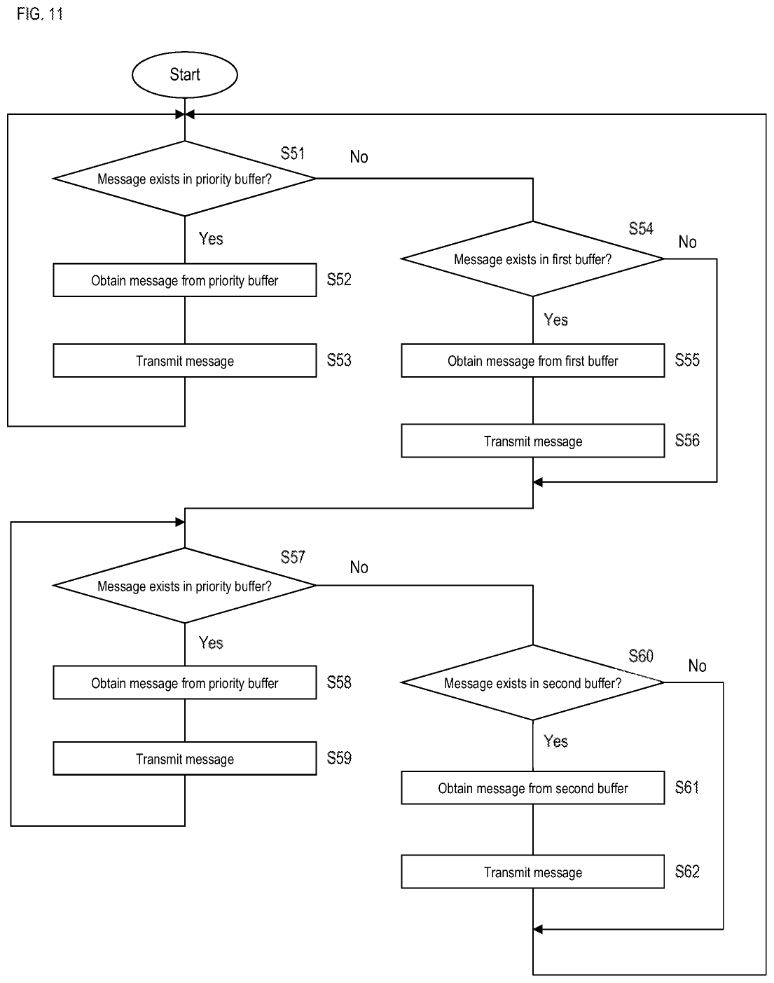

FIG. 10 is a flowchart showing the procedure of message classification processing that is performed by the GW 10 according to Modified Example 2. The classification processing unit lib of the processing unit 11 of the GW 10 according to Modified Example 2 determines whether or not there is a message that is to be transmitted to the other GW 10 (step S31). If there is no message that is to be transmitted to the other GW 10 (step S31: NO), the classification processing unit lib waits until a message that is to be transmitted to the other GW 10 is supplied. If there is a message that is to be transmitted to the other GW 10 (step S31: YES), the classification processing unit lib obtains the ID included in this message (step S32).

The classification processing unit lib determines whether or not this message is a higher-priority message, by comparing the ID obtained in step S32, in other words the priority, with the predetermined threshold value (step S33). If this message is a high-priority message (step S33: YES), the classification processing unit lib classifies this message as a priority message, stores the message in the priority buffer 17c (step S34), and returns the procedure to step S31.

If this message is not a high-priority message (step S33: NO), the classification processing unit 11b references the load table 12b stored in the storage unit 12, based on the ID obtained in step S32 (step S35). The classification processing unit lib determines whether or not the communication load of this message is large, based on the result of referencing the load table 12b (step S36). If the communication load is large (step S36: YES), the classification processing unit lib classifies this message into the first group, stores the message in the first buffer 17a corresponding to the first group (step S37), and returns the procedure to step S31. If the communication load is not large (step S36: NO), the classification processing unit lib determines whether or not the communication load of this message is small (step S38). If the communication load is small (step S38: YES), the classification processing unit lib classifies this message into the second group, stores this message in the second buffer 17b corresponding to the second group (step S39), and returns the procedure to step S31. If the communication load of this message is not small (step S38: NO), in other words if the communication load is intermediate, the classification processing unit lib alternately stores this message in the first buffer 17a or the second buffer 17b (step S40), and returns the procedure to step S31.

FIG. 11 is a flowchart showing the procedure of message transmission processing that is performed by the GW 10 according to Modified Example 2. The transmission processing unit 11c of the GW 10 according to Modified Example 2 determines whether or not a message is stored in the priority buffer 17c (step S51). If a message is stored in the priority buffer 17c (step S51: YES), the transmission processing unit 11c obtains this message from the priority buffer 17c (step S52). The transmission processing unit 11c supplies the obtained message to the communication unit 14, thereby transmits this message to the other GW 10 (step S53), and returns the procedure to step S51. If no message is stored in the priority buffer 17c (step S51: NO), the transmission processing unit 11c advances the procedure to step S54.

Next, the transmission processing unit 11c determines whether or not a message is stored in the first buffer 17a (step S54). If a message is stored in the first buffer 17a (step S54: YES), the transmission processing unit 11c obtains this message from the first buffer 17a (step S55). The transmission processing unit 11c supplies the obtained message to the communication unit 14, thereby transmits this message to the other GW 10 (step S56), and advances the procedure to step S57. In addition, if no message is stored in the first buffer 17a (step S54: NO), the transmission processing unit 11c advances the procedure to step S57.

Next, the transmission processing unit 11c determines whether or not a message is stored in the priority buffer 17c (step S57). If a message is stored in the priority buffer 17c (step S57: YES), the transmission processing unit 11c obtains this message from the priority buffer 17c (step S58). The transmission processing unit 11c supplies the obtained message to the communication unit 14, thereby transmits this message to the other GW 10 (step S59), and returns the procedure to step S57. If no message is stored in the priority buffer 17c (step S57: NO), the transmission processing unit 11c advances the procedure to step S60.

Next, the transmission processing unit 11c determines whether or not a message is stored in the second buffer 17b (step S60). If a message is stored in the second buffer 17b (step S60: YES), the transmission processing unit 11c obtains this message from the second buffer 17b (step S61). The transmission processing unit 11c supplies the obtained message to the communication unit 14, thereby transmits this message to the other GW 10 (step S62), and returns the procedure to step S51. In addition, if no message is stored in the second buffer 17b (step S60: NO), the transmission processing unit 11c returns the procedure to step S51.

A message that is transmitted/received in the in-vehicle communication system 1 according to Modified Example 2 that has the above-described configuration has an ID indicating the priority of the message assigned thereto. The GW 10 according to Modified Example 2 transmits, to the other GW 10, a message with a higher priority than the predetermined threshold value more preferentially than messages classified into the first and second groups. Accordingly, it is possible to prevent the occurrence of a delay of a message that is to be preferentially transmitted.

Each apparatus in the in-vehicle communication system includes a computer constituted by a microprocessor, a ROM, a RAM, and the like. A computation processing unit such as a microprocessor reads out a computer program that includes some or all of the steps in a sequence chart or a flowchart such as those shown in FIGS. 6 to 8, 10, and 11, from a storage unit such as a ROM or a RAM, and executes the program. Computer programs of these apparatuses can be installed from an external server apparatus or the like. Also, computer programs of these apparatuses are distributed in a state of being stored in a recording medium such as a CD-ROM, a DVD-ROM, or a semiconductor memory.

The embodiments disclosed herein are to be considered as illustrative and non-limiting in all aspects. The scope of the present disclosure is indicated not by the above-stated meanings but by the claims, and all changes that come within the meaning and range of equivalency of the claims are intended to be embraced therein.

1. An in-vehicle communication apparatus comprising:
a classification processing unit that performs processing for classifying messages that are to be transmitted to another apparatus, into a plurality of groups; and
a message transmission unit that selects a group in a predetermined order, and transmits a message classified into the selected group, to the other apparatus.

2. The in-vehicle communication apparatus according to claim 1, which is to be connected to the other apparatus via a plurality of communication lines,
wherein the message transmission unit selects a group in a predetermined order and transmits a message, for each of the communication lines.

3. The in-vehicle communication apparatus according to claim 1,
wherein the classification processing unit classifies messages that are to be transmitted to the other apparatus, into a first group and a second group, and
the message transmission unit alternately transmits, to the other apparatus, a message classified into the first group and a message classified into the second group.

4. The in-vehicle communication apparatus according to claim 1, wherein the classification processing unit classifies a message in accordance with whether a communication load of the message is large or small.

5. The in-vehicle communication apparatus according to 4,
wherein the message includes identification information, and
the classification processing unit classifies the message based on information regarding a correspondence between the identification information and communication load of the message, and
an update unit that updates the correspondence information based on a history of message transmission to the other apparatus is provided.

6. The in-vehicle communication apparatus according to claim 1,
wherein the message includes priority information, and
the message transmission unit preferentially transmits a message with a predetermined priority, regardless of classification into one of the plurality of groups.

7. A communication program that causes an in-vehicle communication apparatus to perform processing for:
classifying messages that are to be transmitted to another apparatus, into a plurality of groups; and
selecting a group in a predetermined order and transmitting a message classified into the selected group, to the other apparatus.

8. A message transmission method, comprising:
classifying messages that are to be transmitted to an apparatus, into a plurality of groups, and
selecting a group in a predetermined order and transmitting a message classified into the selected group, to the apparatus.

9. The in-vehicle communication apparatus according to claim 2,
wherein the classification processing unit classifies messages that are to be transmitted to the other apparatus, into a first group and a second group, and
the message transmission unit alternately transmits, to the other apparatus, a message classified into the first group and a message classified into the second group.

10. The in-vehicle communication apparatus according to claim 2, wherein the classification processing unit classifies a message in accordance with whether a communication load of the message is large or small.

11. The in-vehicle communication apparatus according to claim 3, wherein the classification processing unit classifies a message in accordance with whether a communication load of the message is large or small.

12. The in-vehicle communication apparatus according to claim 2,
wherein the message includes priority information, and
the message transmission unit preferentially transmits a message with a predetermined priority, regardless of classification into one of the plurality of groups.

13. The in-vehicle communication apparatus according to claim 3,
wherein the message includes priority information, and
the message transmission unit preferentially transmits a message with a predetermined priority, regardless of classification into one of the plurality of groups.

14. The in-vehicle communication apparatus according to claim 4,
wherein the message includes priority information, and
the message transmission unit preferentially transmits a message with a predetermined priority, regardless of classification into one of the plurality of groups.

15. The in-vehicle communication apparatus according to claim 5,
wherein the message includes priority information, and
the message transmission unit preferentially transmits a message with a predetermined priority, regardless of classification into one of the plurality of groups.
